(19) United States
(12) Patent Application Publication
(10) Pub. No.: US 2024/0391308 A1
(43) Pub. Date: Nov. 28, 2024

(54) FLOOR SUBASSEMBLY FOR AN ELECTRIC VEHICLE

(71) Applicant: FORD GLOBAL TECHNOLOGIES, LLC, Dearborn, MI (US)

(72) Inventors: Joergen HILMANN, Leverkusen (DE); Daniel MECKENSTOCK, Wuppertal (DE); AmirReza LATIF, Grosse Pointe, MI (US)

(73) Assignee: FORD GLOBAL TECHNOLOGIES, LLC, Dearborn, MI (US)

(21) Appl. No.: 18/671,040

(22) Filed: May 22, 2024

(30) Foreign Application Priority Data
May 23, 2023 (DE) 102023113444.2

(51) Int. Cl. B60K 1/04; B60L 50/60; B60N 2/005; B62D 25/20; H01M 50/204; H01M 50/249; H01M 50/262; H01M 50/271

(52) U.S. Cl. CPC B60K 1/04; B60L 50/66; B60N 2/005; B62D 25/2009; H01M 50/204; H01M 50/249; H01M 50/262; H01M 50/271; B60K 2001/0438; H01M 2220/20

(57) ABSTRACT

A floor subassembly for an electric vehicle includes a frame arranged horizontally at an edge of a frame interior, a battery module having a horizontally extending top plate covering the top of a battery unit and fastened to a lower region of the frame forming a vehicle floor in the region of the frame interior. At least one structural element is fastened to the top plate and extends in the frame interior toward the frame and is spaced from the frame by an installation gap at each end of the structural element. The frame is connected to each structural element by at least one holding element that bridges the installation gap.

### CROSS-REFERENCE TO RELATED APPLICATIONS

This application claims foreign priority benefits under 35 U.S.C. § 119(a)-(d) to DE Application 10 2023 113 444.2 filed May 23, 2023, which is hereby incorporated by reference in its entirety.

### TECHNICAL FIELD

This application relates to a floor subassembly for an electric vehicle.

### BACKGROUND

Electric vehicles or hybrid vehicles require a means for storing considerable amounts of electrical energy, said means generally being a battery pack or a battery module having multiple batteries, for example lithium-ion batteries. Aside from the batteries, the battery module may have a housing, in which the batteries are arranged, and fastening elements, such as brackets or the like, for fastening the module to the vehicle. For various reasons, the battery module is normally installed in or under a floor structure of the vehicle. The floor structure has a floor panel (generally a sheet-metal floor panel) which, from a mechanical aspect, downwardly closes off the vehicle interior, for example the passenger cabin. Said floor panel may be fastened to a frame which is formed, at the sides, by sills and at the front by, for example, a dashboard reinforcement or an incorporated or mounted crossmember. Seat crossmembers are often fastened on the floor panel, said seat crossmembers being fastened to the side sills. Said seat crossmembers may in turn serve for the fastening of a seat substructure, for example by virtue of seat rails being screwed or fastened in some other way to the seat crossmembers.

One known design provides for the battery module to have a top plate, for example as part of the aforementioned housing, said top plate being arranged under the floor panel. It has also already been proposed to integrate the floor panel into the battery module such that said floor panel simultaneously forms the top plate of the housing, making it possible to achieve a weight reduction and a smaller number of components. During the assembly process, the battery module, including the floor panel having the seat crossmembers fastened thereto, is then introduced to the frame from below, and the floor panel is fastened to the frame from below. The seat crossmembers that project upward from the floor panel, and any further elements such as a tunnel reinforcement, project upward into the space within the frame. In order to ensure that an installation process is not disrupted owing to component tolerances, a horizontal gap must be allowed for between the elements connected to the floor panel (seat crossmember etc.) and the frame. Thus, even in the assembled state, no connection is provided between the frame and these elements, and therefore no direct transmission of force from the frame to said elements, which significantly impairs the energy-absorbing characteristics.

U.S. Pat. No. 10,766,537B2 discloses a vehicle side-part structure, comprising a pair of sills, which are arranged at the outer sides of a floor panel of a vehicle, and multiple crossmembers, which are arranged with their longitudinal directions in the vehicle width direction, wherein the two longitudinal end portions of each crossmember are fastened to the pair of sills, and the crossmembers are arranged so as to be spaced apart in the vehicle longitudinal direction.

US2019/0210659A1 discloses a lateral vehicle body reinforcement structure, comprising a central floor panel, which forms a floor surface of a vehicle body, a side sill connected laterally to said central floor panel, a seat crossmember, the lower end portion of which is connected to the central floor panel and the lateral end portions of which are connected to the side sill, a battery housing, which is connected to a lower face of the central floor panel and which is arranged on an inner side of the side sill, and a partition panel, which is arranged on first and second side panels of the battery housing in the width direction of the vehicle body. A combination bolt is designed to be passed through the seat crossmember and the central floor panel in succession and engaged with the partition panel.

US2020/0062311A1 presents a vehicle side portion structure comprising a pair of sills, which are arranged at each of the two outer sides, in the vehicle transverse direction, of an underbody of a vehicle and which extend along a vehicle longitudinal direction, and a battery, which is arranged between the pair of sills at an underside of the underbody and which outputs electrical energy to a motor. Furthermore, movement-allowing portions are provided which, when a predefined setpoint load acts on a second sill, said second sill being positioned on a side opposite a first sill, allow a movement of the second sill in the direction of a vehicle outer side at least along a direction of action of the load.

### SUMMARY

Various embodiments according to the disclosure optimize integration of a battery module into a floor subassembly of an electric vehicle by means of a floor subassembly.

Note that the features and measures individually specified in the following description may be combined with one another in any technically meaningful way and reveal further refinements not specifically illustrated or described in detail.

In one or more embodiments, a floor subassembly for an electric vehicle, more specifically of a road-going vehicle such as a passenger motor vehicle, a bus, a heavy goods vehicle or the like, is provided. Here, the term “electric vehicle” also encompasses hybrid vehicles. In any case, the vehicle may be powered entirely or at least intermittently by an electric motor. The entire floor subassembly is arranged in the region of, and at least partially forms, the vehicle floor. Said floor subassembly may belong, at least in part, to a self-supporting body or to a chassis.

The floor subassembly has a frame which is arranged horizontally at the edge of a frame interior. Terms such as “horizontal”, “vertical”, “up”, “down” etc. always relate, here and below, to the intended installed state of the floor subassembly in a vehicle. The same applies to references to the vehicle longitudinal axis (X), which points rearward counter to the direction of travel, the vehicle transverse axis (Y), which points to the right as viewed in the direction of travel, and the upwardly pointing vehicle vertical axis (Z). It can also be stated that the frame interior is formed, as viewed in a horizontal plane, between mutually opposite parts of the frame. Here, the frame may preferably surround the frame interior in fully encircling fashion, that is to say may be of closed annular form. It would however also be possible for said frame to be open on one side, or to consist only of two oppositely situated parts that are not directly connected to one another. The frame preferably has at least two sills which extend along the vehicle longitudinal axis and which are spaced along the vehicle transverse axis. Additionally, a transverse connection is normally provided between the sills at a front end and/or at a rear end. Altogether, the frame may have multiple sheet-metal formed parts or be formed from sheet-metal formed parts. The individual sheet-metal formed parts may be connected in a manner known per se, for example by riveting, welding or adhesive bonding. Aside from sheet metal, use may however also be made of other materials, for example composite materials such as fiber-reinforced plastics material. In an installed state, the frame may be upwardly adjoined by an A pillar, a B pillar and a C pillar of the body. The aforementioned pillars are either non-detachably connected to the frame or may also be formed at least partially integrally therewith. At a front end, the frame may form a dashboard reinforcement. For as long as the frame has not been connected to other components, the frame interior is downwardly and preferably also upwardly open.

The floor subassembly furthermore has a battery module. The term “battery subassembly” could also be used instead of “battery module”. The battery module has a horizontally extending top plate designed to cover the top of a battery unit, which top plate is fastened to a lower region of the frame and forms a vehicle floor in the region of the frame interior. The top plate is provided for upwardly covering a battery unit and thus protecting said battery unit against mechanical influences, moisture etc. The battery unit, which consists of a battery or normally multiple batteries, may be part of the battery module. Said battery unit serves for storing electrical energy for the propulsion of the electric vehicle, and for other vehicle systems. Although the invention is not restricted to a particular type of battery unit, the at least one battery may in particular be a lithium-ion, lithium-polymer or solid-state battery. A bottom plate may be provided on an underside of the battery unit, which bottom plate provides mechanical and other protection. The top plate (and the bottom plate, if present) may be part of a housing that encloses the battery unit. The top plate extends along the horizontal plane and may run at least partially parallel thereto. The profile of said top plate may however also locally deviate, for example owing to beads or embossments which structurally stabilize the top plate, or owing to structures that facilitate the connection to the frame. The top plate is connected to a lower region of the frame, such that at least part of the frame projects upward beyond the top plate along the vertical axis. Aside from its function for protecting the battery unit, the top plate also serves as a vehicle floor in the region of the frame interior. Here, the top plate may be arranged at least partially in the frame interior, or may downwardly close off the frame interior. The vehicle floor may also be referred to as a cabin floor, and downwardly mechanically closes off the vehicle interior (normally a passenger cabin). That is to say, said vehicle floor forms a barrier against mechanical influences, and normally also against moisture and dirt.

The battery module furthermore has at least one structural element which is fastened to the top plate, extends in the frame interior toward the frame and, at the ends, is spaced from said frame by an installation gap. Depending on the embodiment, the structural element may also be referred to as a carrier element, stiffening element or support element. Said structural element may be fastened in interlocking, frictional and/or integrally bonded fashion to the top plate. Said structural element is thus arranged on top of the top plate. Said structural element may under some circumstances also be formed at least partially integrally with the top plate, but in most embodiments is an element that is manufactured separately from, and retroactively connected to, the top plate. The structural element may be formed as a profiled part, for example with a rectangular profile, U-shaped profile or top-hat-shaped profile, but is not restricted hereto. Typically, a direction of extent can be identified, along which the structural element as a whole extends, although embodiments are conceivable in which the structural profile is characterized by a significant change in direction, that is to say is for example bent and/or angled. In the simplest case, said structural element has a profile that is invariant along the direction of extent. Said structural element is arranged at least partially, preferably predominantly or entirely, in the frame interior. Within the frame interior, said structural element extends towards the frame. Said structural element is however not in direct contact with the frame and, at the ends, is spaced from said frame by an installation gap. More specifically, said structural element is horizontally spaced from the frame. During the process of assembly of the floor subassembly, the battery module, including the top plate and the at least one structural element fastened thereto, is introduced to the frame from below, with the structural clement being introduced into the frame interior, whereby said structural element is brought vertically to the level of the frame. Without the installation gap, the dimensions of the structural element would theoretically be exactly adapted to the frame, and said structural element could lie against said frame without any gaps. It is however necessary in practice to allow for component tolerances, which could result in interference between the structural element and the frame. In the worst case, it would not be possible at all for the structural element to be introduced into the frame interior.

According to one or more embodiments, the frame is connected to a structural clement by means of at least one holding element that bridges the installation gap. Each holding element, which can also be referred to as bracket, bridging element or the like, thus creates an additional connection, independent of the top plate, between the frame and the structural element. The holding element bridges the installation gap and may in particular overlap the structural clement within the horizontal plane. In typical embodiments, it can be stated that the holding element projects from the frame into the frame interior. In principle, the connection of the holding clement both to the frame and to the structural element may be of interlocking, frictional and/or integrally bonded form. With regard to possible uninstallation of the battery module, the holding element may be detachably connected to the structural element. The connection to the frame may in principle be detachable or non-detachable. During the installation process, the frame may form a preinstalled unit with the relevant holding element, with the battery module being introduced to said unit, and connected thereto, from below. To establish the connection, the top plate is firstly connected to the frame, and secondly, at least one holding element is connected to the structural element. To allow the battery module to be uninstalled in its entirety, a detachable connection is preferably established, for example by means of screws.

The floor subassembly allows the battery module to be easily installed, wherein the dual function of the top plate contributes to minimizing the number of parts, the weight, and the complexity of the installation process. Owing to the installation gap, disruption-free installation is possible even in the case of a relatively large manufacturing tolerance. Nevertheless, the at least one holding clement ensures an optimum connection of the frame to the particular structural clement. It is thus possible for even significant forces to be transmitted between the frame and the structural element. In particular, with a suitable design of the holding element, it is possible for a force component to be transmitted in a direction of extent of the structural element. The structural element in turn can often absorb forces optimally in the direction of extent. The frame can therefore be indented less easily and, if at all, only with significant absorption of energy by the structural element. Altogether, the floor subassembly is thus stabilized, which can serve both to protect the passenger cell situated thereabove and to protect the battery unit.

During the installation process, when the battery module is connected to the frame, the battery module is introduced to the frame from below. The subsequent connection process can be performed particularly effectively if an edge region of the top plate lies against the frame from below. That is to say, the top plate is of larger dimensions, in cross section, than the frame interior, and therefore comes to lie against the frame at the sides of the frame interior. Since the top plate forms the vehicle floor, which is normally intended to provide protection against an ingress of water or dirt, the top plate preferably lies against the frame in fully encircling fashion around the frame interior. Here, it is for example possible for a flexible seal to be provided in order to establish an at least liquid-tight connection. A detachable connection between the frame and the top plate may be implemented for example by means of screws, which are guided from below through through-holes in the top plate and engage with internal threads provided on the frame.

In one refinement, at least one structural element extends along the vehicle transverse axis and, at at least one end as viewed along the vehicle transverse axis, is connected to the frame by means of a holding element. At least in some embodiments, the corresponding structural element may also be referred to as a crossmember. The structural element extends along the vehicle transverse axis. It may, but does not necessarily, run at least partially parallel to said vehicle transverse axis. The aforementioned installation gap is formed between the structural clement and the frame along the vehicle transverse axis. The associated holding element must correspondingly extend along the vehicle transverse axis. Said holding element can establish a connection to a laterally arranged sill of the frame.

It is alternatively or additionally also possible for at least one structural element to extend along the vehicle longitudinal axis and, at an end as viewed along the vehicle longitudinal axis, to be connected to the frame by means of a holding element. This structural element may extend at least partially parallel to the vehicle longitudinal axis. The aforementioned installation gap is formed between the structural element and the frame along the vehicle longitudinal axis. The associated holding element must correspondingly extend along the vehicle longitudinal axis. In this case, the holding element normally establishes a connection not to a laterally arranged sill but to a front or rear region of the frame that extends along the transverse axis, for example to a dashboard reinforcement. The structural element may be a tunnel reinforcement. Aside from the connection to the frame and to the top plate, such a structural element that runs in the longitudinal direction and a structural element that runs in the transverse direction may also be directly connected to one another, for example by welding.

Preferably, at least one holding element has a horizontally extending top portion, which is arranged on top of a structural element. The top portion extends horizontally, that is to say along a horizontal plane spanned by the longitudinal axis and by the transverse axis, but does not necessarily run parallel to said plane. Said top portion preferably runs at an angle of between 0° and 30° with respect to the horizontal plane. Said top portion is arranged on top of the structural clement. Said top portion normally lies at least partially on top of the structural element, but it would also be conceivable for said top portion to be spaced from the structural element by a further interposed element. The top portion may be planar, for example in the form of a sheet-metal formed part or a portion of a sheet-metal formed part. Said top portion is preferably fastened to the structural element, which may be implemented by means of an interlocking, frictional and/or integrally bonded connection. The top portion may be directly connected to the frame, which connection may likewise be implemented in interlocking, frictional and/or integrally bonded form.

Under some circumstances, a holding element may have only the aforementioned top portion. Alternatively or in particular in addition to a top portion, it is advantageously possible for at least one holding element to have a vertically extending side portion, which is arranged horizontally to the side of a structural element. If the holding element also has a top portion, the side portion is preferably formed integrally with said top portion. In particular, the holding element may directly adjoin the top portion. The side portion extends downward in relation to the top portion. The side portion extends vertically, that is to say extends along the vertical axis, but does not necessarily run parallel thereto. Said side portion preferably runs at an angle of between 0° and 30° with respect to the vertical axis. The side portion is arranged horizontally to the side of the structural element. This normally corresponds to an arrangement to the side transversely with respect to the direction of extent of the structural element. The side portion may be planar, for example in the form of a sheet-metal formed part or a portion of a sheet-metal formed part. The holding clement preferably has two side portions, which are arranged on opposite sides of the structural element. That is to say, the structural element is received between the side portions. In particular, at least one holding element having a top portion and two side portions may be designed as a downwardly open U-shaped profile. Each side portion is preferably fastened to the structural element, which may be implemented by means of an interlocking, frictional and/or integrally bonded connection. Each of the side portions may be directly connected to the frame, which connection may likewise be implemented in interlocking, frictional and/or integrally bonded form. If a top portion and at least one side portion are present, it is however also possible for one of the two portions to be connected to the frame only indirectly via the other portion.

One embodiment provides for at least one holding element to lie against a structural element. This can be implemented for example if both the structural element and the holding element are in the form of sheet-metal formed parts, the profiles of which are adapted to one another. In any case, they have contact surfaces which are coordinated with one another and which lie against one another in the installed state. The corresponding contact surfaces may be entirely or partially adhesively bonded to one another, though other connection types are also conceivable, for example welding or connection by interlocking means such as screws or rivets.

It is possible, and may also be expedient, for the side portions to be fastened to the structural element. This, in addition to the connection of the top portion, can serve for increased stability and an optimum introduction of force into the structural element. It must however be taken into consideration that, during the assembly process, the structural element is introduced between the mutually opposite side portions from below. Owing to component tolerances, it is expedient to select the spacing of the side portions to be somewhat greater than the width of the structural clement, such that said structural element can be introduced without interference. The side portions may accordingly be at least partially horizontally spaced from the structural element. The spacing normally lies in the range of a few millimeters. At the same time, areal or punctiform connections may be provided between the side portion and the structural element, which connections have been produced for example by plastic and/or elastic deformation of the structural element and/or of the holding element.

At least one structural element may be designed for the fastening of a vehicle seat substructure. The corresponding structural element normally extends along the vehicle transverse axis toward the frame. Said structural element may run entirely or partially parallel to the vehicle transverse axis. Said structural element may accordingly also be referred to as a crossmember or seat crossmember. The vehicle seat substructure is fastened to the corresponding structural element, for example by screw connection or riveting. In general, the vehicle seat substructure either forms the lower part of the vehicle seat or has at least one seat rail to which a vehicle seat (for example a driver or front passenger seat) is movably connected when in the installed state. Here, the structural element serves to absorb forces from the vehicle seat and transmit them to the top plate and to the frame. Each vehicle seat substructure may be fastened to one or more structural elements. It is likewise possible for multiple vehicle seat substructures to be fastened to one structural clement. Optionally, the vehicle seat substructure or even the entire vehicle seat may form a part of the battery module and be introduced through the frame interior into the vehicle from below during the assembly of the vehicle. For the maintenance or exchange of batteries, it is likewise possible for the battery module including the vehicle seat substructure, and optionally the vehicle seat, to be uninstalled from the frame.

One option is for the structural element to be connected to the holding element by means of one connection and to the vehicle seat substructure by means of another connection. For example, the two connections may each be implemented by means of dedicated screws or rivets. However, if it is possible or intended for the vehicle seat substructure to be connected, as a pre-installed part of the battery module, to the frame, one common connection may be used for all three elements. One corresponding embodiment provides for at least one structural element and a holding element connected thereto to have mutually aligned through-holes, through which a connecting element can be passed in order to fasten the vehicle seat substructure, the structural element and the holding element to one another. The connecting element may in particular be a screw or a rivet. Said connecting element is passed through the through-holes in the structural clement and holding clement and optionally through a through-hole in the vehicle seat substructure, whereby an at least partially interlocking connection of all three elements is possible. The stability of the connection of the vehicle seat substructure can thus be increased. Furthermore, the number of parts is reduced, the weight can be reduced, and the assembly of the floor subassembly (including the vehicle seat substructure) is simplified.

Further advantageous details and effects will be discussed in more detail below on the basis of one or more representative embodiments illustrated in the figures, in which:

### BRIEF DESCRIPTION OF THE DRAWINGS

FIG. 1 is a perspective illustration of a first embodiment of a frame of a floor subassembly;

FIG. 2 is a perspective illustration of a battery module of a floor subassembly;

FIG. 3 is a perspective illustration of a first embodiment of a floor subassembly;

FIG. 4 is a sectional illustration of a detail of the floor subassembly from FIG. 3;

FIG. 5 is a sectional illustration corresponding to the line V-V in FIG. 4;

FIG. 6 is a sectional illustration of a detail of a second embodiment of a floor subassembly; and

FIG. 7 is a perspective illustration of a second embodiment of a frame of a floor subassembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the various figures, identical parts are always denoted by the same reference designations, for which reason said parts will generally also be described only once.

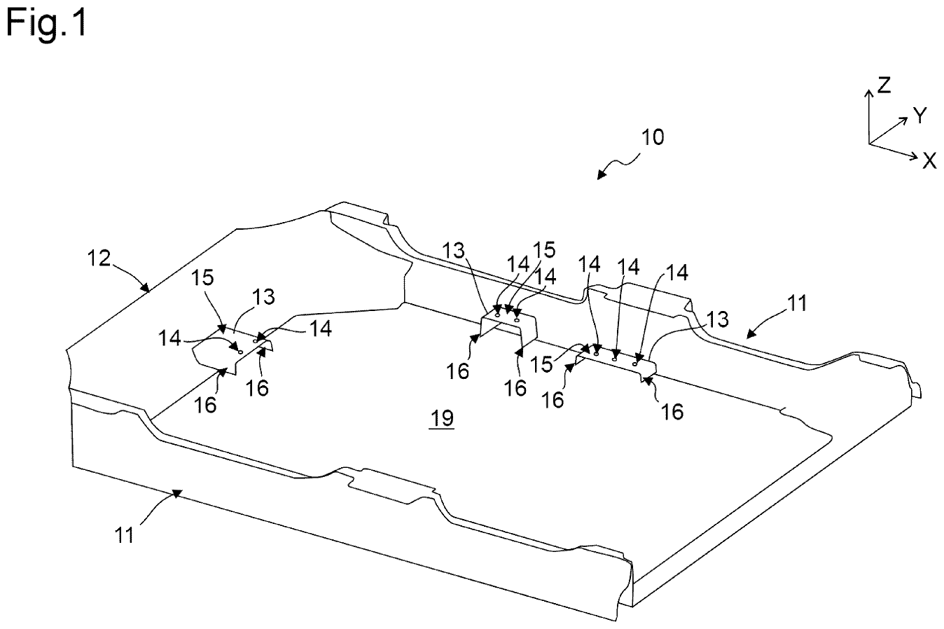

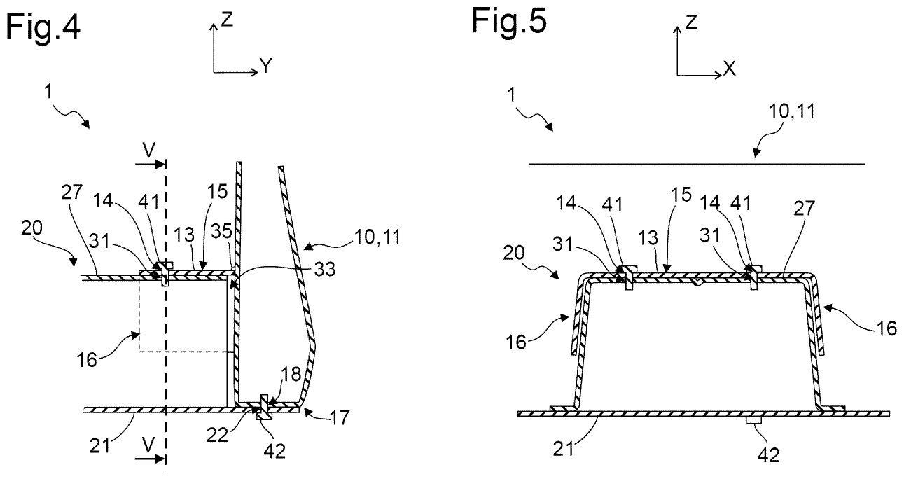

FIG. 1 shows a first embodiment of a frame 10 for a floor subassembly 1 of a vehicle, which will hereinafter also be referred to as an electric vehicle. In each of the figures, the longitudinal axis X, the transverse axis Y and the vertical axis Z of the electric vehicle are illustrated, in each case based on the intended installation position of the component illustrated in the particular figure. The frame 10 peripherally surrounds a frame interior 19, which is open in both directions along the vertical axis Z. The frame 10 has, at the sides along the transverse axis Y, two sills 11 that extend approximately parallel to the longitudinal axis X. Counter to the direction of orientation of the longitudinal axis X, the frame 10 has, at a front end, that is to say on the left-hand side as seen in the plane of the drawing in FIG. 1, a dashboard reinforcement 12 that extends along the transverse axis Y. The frame 10 may consist at least predominantly or entirely of sheet steel, as is known per se. Multiple holding elements 13 are arranged on the frame 10 and project inwardly into the frame interior 19. More specifically, two holding elements 13 are fastened to each sill 11, whilst a further holding element 13 is fastened to the dashboard reinforcement 12. In this example, the holding elements 13 are welded to the frame 10 by means of weld seams 35 (see FIG. 4), that is to say are non-detachably connected to said frame. Each holding element 13, which is likewise formed as a sheet-metal formed part, has a horizontally extending top portion 15 and, to both sides thereof, downwardly extending side portions 16, resulting overall in a downwardly open U-shaped profile. First through-holes 14, the function of which will be discussed below, are also formed in the top portion 15.

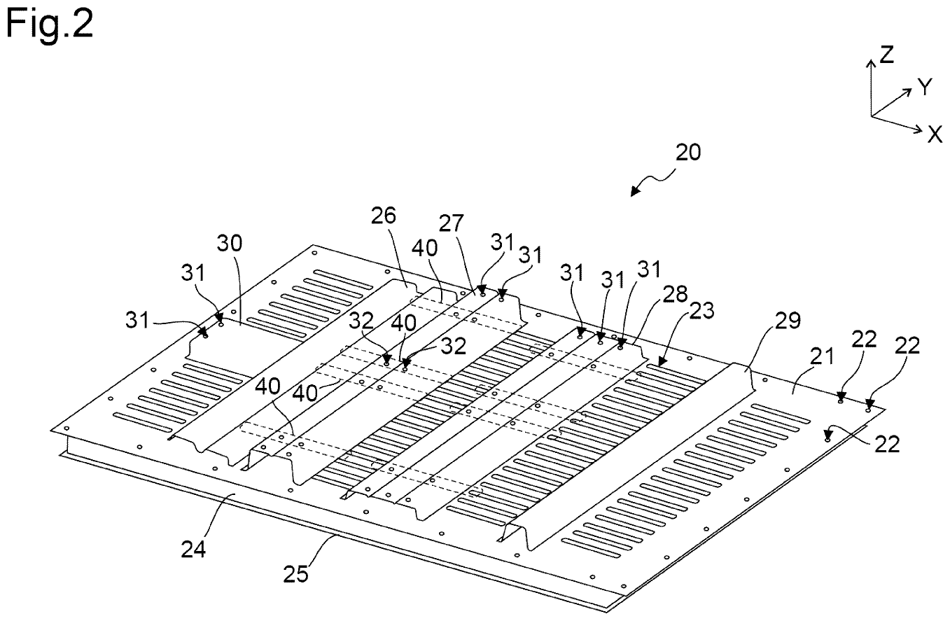

FIG. 2 shows a battery module 20 for the floor subassembly 1. Said battery module has a top plate 21 consisting of sheet steel, which top plate has second through-holes 22 arranged at the edges and has multiple embossments 23 for stabilization purposes. The top plate 21 upwardly covers a battery unit 24, which is shown in highly schematic form here. The battery unit 24 has multiple batteries, which can serve as an energy source for a drive and for other systems of the electric vehicle. A bottom plate 25 is arranged on the underside of the battery unit 24. The top plate 21, the battery unit 24 and the bottom plate 25 are connected to one another in a manner that is not illustrated here. Arranged on top of the top plate 21 are multiple structural elements 26-30, which are fastened to the top plate 21 (for example by adhesive bonding, welding or riveting). Whilst a first to a fourth structural element 26-29 extend along the transverse axis Y between the sills 11, a fifth structural element 30 extends forward along the longitudinal axis X from the first structural element 26 toward the dashboard reinforcement 12. All of the structural elements 26-30 have a top-hat-shaped profile with a top surface parallel to the top plate 21 and sloping sides. The second, third and fifth structural elements 27, 28 and 30 have third through-holes 31 on the top. The second and third structural elements 27, 28 furthermore have fourth through-holes 32 which serve for receiving connecting elements (not illustrated here), such as screws or rivets, by means of which a vehicle seat substructure 40 (illustrated here highly schematically in the form of seat rails) can be fastened. The vehicle seat substructure 40 (indicated here by dashed lines), or optionally the entire vehicle seat, may likewise be pre-installed as part of the battery module 20. The relative positions of the third through-holes 31 correspond to those of the first through-holes 14, that is to say each third through-hole 31 corresponds with one first through-hole 14.

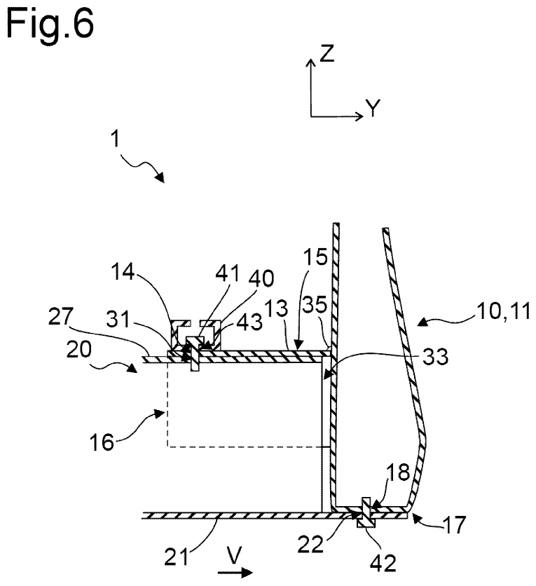

During the course of installation, the battery module 20 is introduced to the frame 10 from below, parallel to the vertical axis Z, until an edge region of the top plate 21 lies against a lower region 17 of the frame 11 from below. In the process, the second through-holes 22 overlap with fifth through-holes 18 within the frame 11, as can be seen in FIG. 4, in which (as in FIGS. 5 and 6) the battery unit 24 and the bottom plate 25 have been omitted merely for the sake of clarity. The fifth through-holes 18 may be provided with an internal thread. As a result of the corresponding positioning of the battery module 20, the second, third and fifth structural elements 27, 28, 30 are positioned at respective holding elements 13 such that the top portion 15 lies on top of the structural element 27, 28, 30 and the side portions 16 are arranged horizontally to both sides of the structural element 27, 28, 30. As can be seen in FIG. 5, a horizontal spacing is formed between each side portion 16 and the structural element 27, 28, 30. This ensures that, even with the given component tolerances, the structural element 27, 28, 30 can be reliably received between the side portions 16. As can be seen in particular from FIG. 4, an installation gap 33 of a few millimeters (2-4 mm) in width is formed between the end of the structural element 27. Said installation gap means that, even in the presence of component tolerances, the structural element 27 can be received between the sills 11 without becoming jammed.

The installation gap 33 is however bridged by the holding element 13. Said holding element is connected to the structural element 27, as shown in FIGS. 4 and 5, by virtue of a first connecting element 41 (in this case a screw) being passed through the mutually aligned first and third through-holes 14, 31 and secured (for example by means of an internal thread in each of the third through-holes 31). A second connecting element 42 is likewise passed in each case through the second through-holes 22 and the fifth through-holes 18. The battery module 20 is thus detachably fastened to the frame 10 and forms a vehicle floor under the frame interior 19. In addition to the fastening of the top portion 15, the side portions 16 may also be fastened to the structural element 27, in a manner not illustrated here. In any case, the connection by means of the holding element 13 makes it possible for force to be introduced from the frame 10 into the particular structural element 27, 28, 30.

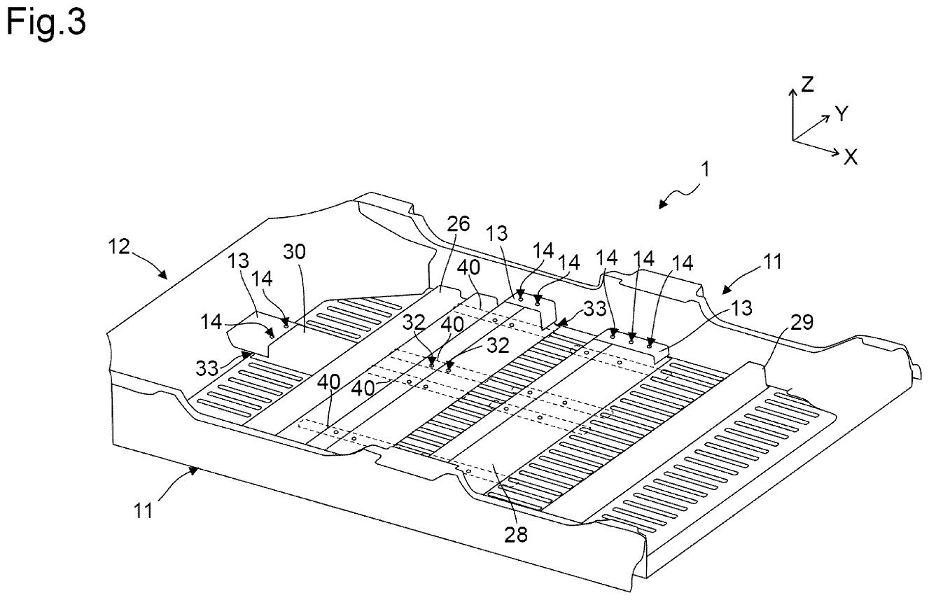

In the representative embodiment illustrated in FIGS. 1 to 5, the vehicle seat substructure 40 is fastened by way of the fourth through-holes 32, which are provided specifically for this purpose, using separate connecting means. FIG. 6 illustrates an alternative representative embodiment in which the holding element 13 extends as far as an intended installation position of the vehicle seat substructure 40. It is thus possible for said vehicle seat substructure to be fastened by means of the first connecting element 41. The first connecting element 41 is passed through a sixth through-hole 43 in the vehicle seat substructure 40, through the first through-hole 14 and through the third through-hole. In this way, both a connection of the structural element 27 to the holding element 13, and an attachment of the vehicle seat substructure 40, are achieved using only a single connecting element 41.

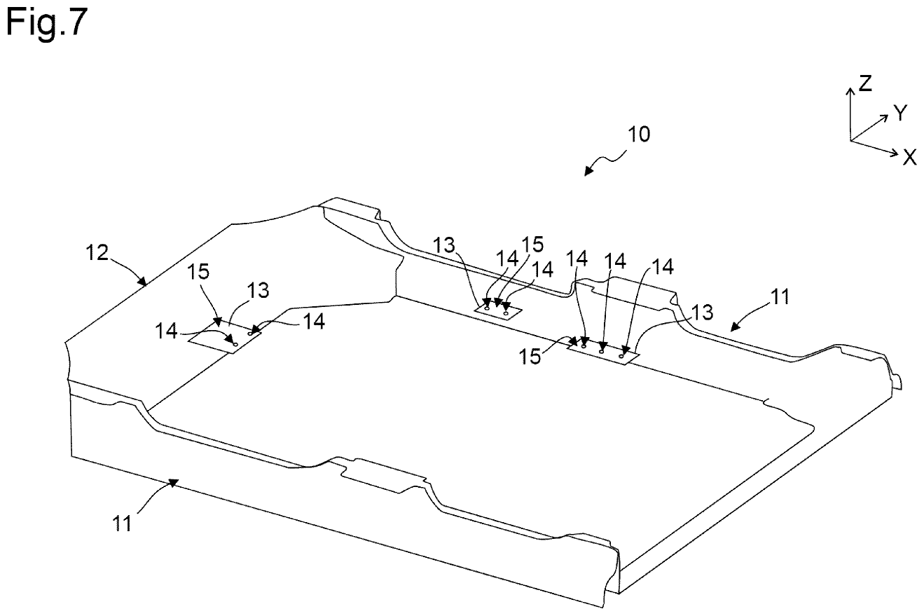

FIG. 7 shows a second embodiment of a frame 10, which substantially corresponds to the first embodiment. However, in this case, holding elements 13 are provided which do not have a U-shaped profile but consist of only the top portion 15. Positioning issues that may arise, owing to manufacturing tolerances, when the structural element is introduced between the side portions can thus be avoided.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electric vehicle floor assembly, comprising:
a frame surrounding a frame interior;
a battery module having a horizontally extending top plate configured to cover a top of a traction battery, the top plate fastened around a perimeter to a lower region of the frame and forming a vehicle floor within the frame interior, the top plate having a plurality of structural elements secured to the top plate and extending across the frame interior toward the frame, each of the plurality of structural elements spaced from the frame by an installation gap at one or both ends of the structural element; and
a plurality of holding elements, each holding element bridging a respective installation gap and connected to both a respective structural element and the frame.

2. The electric vehicle floor assembly of claim 1 wherein an edge along each side of the top plate contacts the frame from below the frame.

3. The electric vehicle floor assembly of claim 2 wherein at least some of the plurality of structural elements extend along a vehicle transverse axis (Y) relative to a vehicle longitudinal axis (X) that extends in a direction of vehicle travel, the plurality of structural elements each including at least one end connected to a respective one of the plurality of holding elements by a plurality of fasteners.

4. The electric vehicle floor assembly of claim 3 wherein at least one of the plurality of structural elements extends along the vehicle longitudinal axis (X).

5. The electric vehicle floor assembly of claim 4 wherein the at least one structural element extending along the longitudinal axis (X) includes a first end connected to one of the plurality of holding elements, and a second end contacting one of the structural elements extending along the vehicle transverse axis (Y).

6. The electric vehicle floor assembly of claim 4 wherein the plurality of holding elements each comprise a horizontally extending top portion arranged on top of an associated structural element.

7. The electric vehicle floor assembly of claim 5 wherein the plurality of holding elements each comprise side portions vertically extending from the horizontally extending top portion.

8. The electric vehicle floor assembly of claim 7 wherein the side portions are spaced from side portions of an associated structural element.

9. The electric vehicle floor assembly of claim 4 wherein at least two of the structural elements are configured for securing a vehicle seat substructure to the at least two structural elements.

10. The electric vehicle floor assembly of claim 9 wherein the plurality of structural elements, the plurality of holding elements, and the vehicle seat substructure include mutually aligned through holes configured to fasten the vehicle seat substructure, to corresponding structural elements and holding elements.

11. An electric vehicle floor assembly, comprising:
a battery module having a horizontally extending top plate configured to cover a top of a traction battery, the top plate configured for fastening around a perimeter to a lower region of a vehicle frame and forming a vehicle floor within a frame interior; and
a plurality of structural elements secured to the top plate and extending across the frame interior toward the frame, each of the plurality of structural elements sized to be spaced from the frame by an installation gap at one or both ends of the structural element after installation, wherein each of the plurality of structural elements extends in a transverse direction (Y) relative to a longitudinal axis (X) along a direction of travel after installation in an electric vehicle, at least two of the plurality of structural elements adapted to secure a seat substructure.

12. The electric vehicle floor assembly of claim 11 further comprising:
a vehicle frame, wherein the vehicle frame includes a plurality of holding elements, each holding element bridging a respective installation gap and connected to both a respective structural element and the vehicle frame, and wherein an edge along each side of the top plate contacts the frame from below the frame.

13. The electric vehicle floor assembly of claim 11 wherein each of the holding elements comprises a horizontally extending surface connecting two vertically extending sides.

14. The electric vehicle floor assembly of claim 13 wherein a first one of the structural elements extends parallel to the longitudinal axis (X) and contacts a second one of the structural elements extending in the transverse direction (Y).

15. The electric vehicle floor assembly of claim 13 wherein at least two of the plurality of structural members are configured for securing a vehicle seat substructure.

16. The electric vehicle floor assembly of claim 13 wherein an edge alone each side of the top plate contacts the vehicle frame from below the vehicle frame.

17. The electric vehicle floor assembly of claim 13 wherein at least some of the plurality of structural elements extend along a vehicle transverse axis (Y) relative to a vehicle longitudinal axis (X) that extends in a direction of vehicle travel, the structural elements each connected to a respective one of the plurality of holding elements by a plurality of fasteners, and wherein at least one of the plurality of structural elements extends along the vehicle longitudinal axis and contacts one of the structural elements extending along the vehicle transvers axis.

18. An electric vehicle comprising the electric vehicle floor assembly of claim 17.

19. The electric vehicle floor assembly of claim 13 wherein the vertically extending sides of each holding element are spaced from side portions of an associated structural element.
